(19) United States
(12) Patent Application Publication
(10) Pub. No.: US 2007/0061635 A1
(43) Pub. Date: Mar. 15, 2007

(54) Handling unwritten areas on a storage medium

(75) Inventors: Robert Albertus Brondijk, Eindhoven (NL); Stephanus Josephus Maria Van Beckhoven, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIKE PHILIPS ELECTRONICS N.V., EINDHOVEN NEHTERLANDS (NL)

(21) Appl. No.: 10/557,382

(22) PCT Filed: May 4, 2004
(86) PCT No.: PCT/IB04/50574

§ 371 Date: Nov. 18, 2005

(30) Foreign Application Priority Data
May 20, 2003 (EP) 03076516.8

(51) Int. Cl. G06F 11/00

(52) U.S. Cl. 714/100

(57) ABSTRACT

A recording device has medium interface means (14) for interfacing with a storage medium (11) for recording data on the medium and retrieving data from the medium, and a host interface (15) for communicating with a host (13) via messages according to a protocol (ATA/ATAPI). The messages include a write command for writing data, and a read command for reading data. In existing protocols (MMC-3) unwritten areas are considered to be areas that are not yet formatted, and zero data is to be returned on a read command. The device has an error reporting unit (16) for reporting an error via an error message in the event that during reading an area is detected which is unwritten.

The invention relates to a device for storing information on a storage medium, the device comprising medium interface means for interfacing with the storage medium for writing data on the medium and reading data from the storage medium, and host interface means for communicating with a host via messages according to a protocol, the messages including a write command for writing data and a read command for reading data.

The invention further relates to a method of storing information on a storage medium, the method comprising communicating with a host via messages according to a protocol, the messages including a write command for writing data and a read command for reading data.

The invention further relates to a method of controlling the device, the method comprising communicating with the device via messages according to a protocol, the messages including a write command for writing data and a read command for reading data.

The invention further relates to a computer program product for storing information on a storage medium, and for controlling the recording device.

Controlling of storing information on a storage medium such as an optical record carrier via a recording device is known from the DVD (Digital Versatile Disk) system and a draft proposal of the National Committee for Information Technology Standards (NCITS): Working Draft, T10/1363-D, Revision 10g, Nov. 12, 2001, “INFORMATION TECHNOLOGY—SCSI Multimedia Commands—(revision MMC10g, in this document further called MMC-3). The device has a medium interface, e.g. a read/write head and positioning system, on one side to interface with the storage medium. On the other side, the recording device has a host interface to communicate with a host, which may be a PC or the application unit of a video recorder. A protocol for communicating between the host and the host interface of the recording device is the ATA/ATAPI standard referred to in MMC-3 (chapter 1) and in particular NCITS T13/1321D AT Attachment with Packet Interface 5 referenced in MMC-3 (chapter 2.1.2), or X3T13/1153D ATA-5 Rev. 17, further called ATA/ATAPI-5. Hence the device may be called an ATA/ATAPI device. Such recording devices may be used for recording real-time data blocks, e.g. video, under the control of the host system. The host accommodates applications like recording or playback of video. In MMC-3 it is specified (see chapter 5.4.3.13.7) that, when reading over an area that not yet has been formatted by writing (called an ICED area) on a +RW disc, the drive shall return zeros in the place of sector data. There are problems with this requirement. For example it is difficult for a drive to differentiate between an unwritten are and a black dot, e.g. a damaged location or a manufacturing flaw.

Therefore it is an object of the invention to provide a system for storing information on a storage medium that allows efficient handling of unwritten areas.

According to a first aspect of the invention the object is achieved with a device for storing information as described in the opening paragraph, the device comprising error reporting means for reporting an error via an error message in the event that during reading an area is detected which is unwritten.

According to a second aspect of the invention the object is achieved with a method of storing information on a storage medium as described in the opening paragraph, the method comprising reporting an error via an error message in the event that during reading an area is detected which is unwritten.

According to a third aspect of the invention the object is achieved with a method of controlling the device as described in the opening paragraph, the method comprising receiving an error message in the event that during reading an area is detected which is unwritten, and reporting the unwritten area to an application.

The effect of the measures is that the device is that the device reports an error when a read command requires reading a part of the storage medium that contains an unwritten area. It is noted that this does not follow the MMC-3 (which requires zeros and no error at this point) because an error is reported when reading ICE. This has the advantage that the application in the host is aware of the unwritten area, and may recover quickly from the likely unexpected) unwritten area and continue reading as soon as possible.

The invention is also based on the following recognition. In practice the record carrier needs to be readable on pre-existing reading and recording devices, for example DVD Digital Versatile Disc) players and DVD+RW recorders. Hence the existing devices require at least said partial formatted state as mentioned in MMC-3 in chapter 5.4.3.13.2. Hence blocks may be unwritten due to the partial formatted state. However the inventors have seen that, in addition, a block may be unwritten (ICE) due to a recording error, which last situation is very serious. During a write action, a block may have been skipped because of a write error. The recording application may try to read the data on the disc to check consistency. It may read an area (which is partly unwritten) and receives zeros (according to MMC-3 for unwritten areas). The inventors noted that zeros may be a user data content. Hence the application will believe that all went well. Error recovery by the recording device may then be omitted. If such a disc is read at a later moment (e.g. in a DVD-ROM drive), the file, in which the unwritten area (ICE) occurred, will be corrupted. This is very serious.

In the MMC command set, it is required that when a DVD+RW write capable drive is issued a read command, and the read-command requests to transfer a sector which is ICED (unwritten), that the drive returns zeros as content. This behavior will cause inconstancies between the reaction of a DVD-ROM drive and a DVD+RW drive and may even lead to data corruption in a host, e.g. a PC. This is because it the reader of an iced sector is not unaware of the iced sector and has no way of knowing the history of that sector. It could be that that sector was supposed to be written, but due to a tracking error of the original writer, it was skipped. The original writer may have then reported an error and the file, that contained the error, may have been properly administrated in the file system. If a DVD-ROM drive reads this file, it will notify the application of an error. However, if a DVD+RW drive follows the specification in MMC, it will not notify the application of an error. This can lead to corruption of the application and even corruption of data used or recorded by the application, e.g. on a hard disc drive. Corruption can occur if the file containing the unwritten areas is an executable file for the host. An executable with corrupted instructions will have unpredictable behavior, e.g. may cause a crash of the host or application system. The inventive step is to recognize this major shortcoming in the MMC specification and to avoid this by returning an error when reading ICE.

The idea behind the MMC specification was born with the thought that a drive shall perform background formatting and therefore all blocks which are unwritten will be written soon, so that a drive, in anticipation of writing, can return zeros “already”; data can be fabricated. The creators of the MMC Specification did not consider the situation that an error results in skipped, unwritten blocks. Skipping blocks also occurs due to fingerprints, i.e. before cleaning such blocks are covered by dirt. If the disc is cleaned, the previously covered blocks can be written and read; however, these blocks may now be part of a corrupted file. Hence the inventors have seen that not reporting an error for unwritten blocks generates problems, and is to be replaced by reporting an error for unwritten areas.

In an embodiment of the device the host interface means are arranged for communicating via the messages including a write command for writing data in real-time and a read command for reading data in real-time. This has the advantage that for real time data the reporting of a read error allows preventing presentations of corrupted data to the user, e.g. preventing loud noise or visual artifacts.

In an embodiment of the device the error reporting means are arranged for detecting an unwritten area by detecting a reflective state of a recording layer of the storage medium. This has the advantage that unwritten areas can be easily detected.

Further preferred embodiments of the method and device according to the invention are given in the further claims.

These and other aspects of the invention will be apparent from and elucidated further with reference to the embodiments described by way of example in the following description and with reference to the accompanying drawings, in which

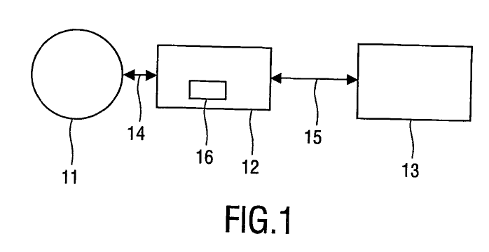

FIG. 1 shows a disc-shaped storage medium, recording device and host system,

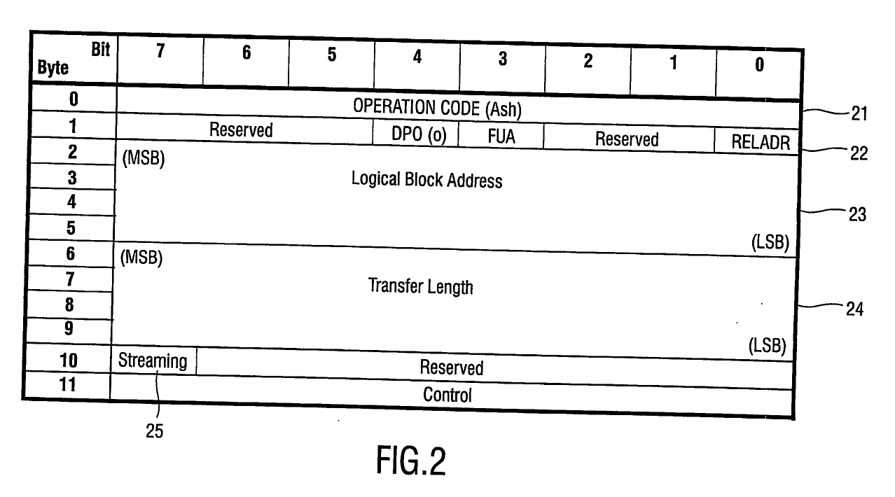

FIG. 2 shows a read command,

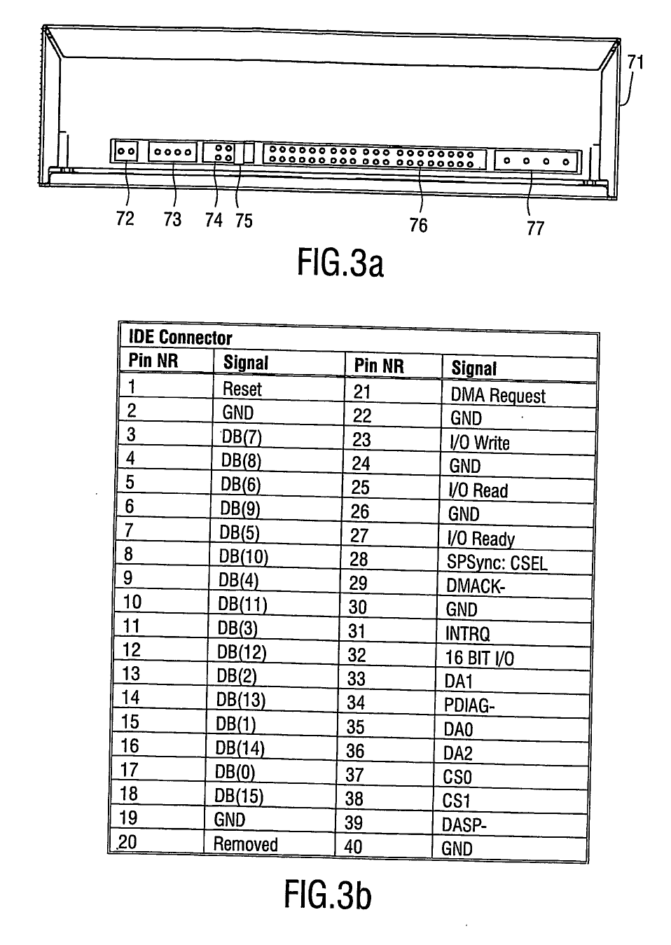

FIG. 3a shows connectors on a drive for interfacing, and

FIG. 3b shows an IDE connector layout

In the Figures, elements which correspond to elements already described have the same reference numerals.

FIG. 1 shows a disc-shaped storage medium, recording device and host system. A storage medium 11, for example an optical disc, constitutes a record carrier for a recording device 12. A DVD+RW is an example of such a record carrier. A number of interfacing functions of the recording device is defined according to a predefined standard, for example ATA/ATAPI-5. Hence the device may be called an ATA/ATAPI device. The device (12) has a medium interface, e.g. a read/write head, positioning servo system and control circuits commonly known from the CD or DVD system, on one side to interface with the storage medium 11, for example the DVD+RW disc. On the other side, the device 12 has a host interface 15, e.g. an ATA cable, to communicate with a host, which may be either a PC or the application side of a video recorder, e.g. having usual elements for input and output of video information. The combination of the four elements: DVD+RW medium, a ATA/ATAPI device plus Host, can form a Consumer DVD+RW Video Recorder.

In existing protocols (MMC-3) unwritten areas are considered to be areas that have not yet been formatted, and zero data is to be returned on a read command. The device has an error reporting unit 16 for reporting an error via an error message in the event that during reading an area is detected which is unwritten. The error message is transferred via the host interface 15 according to the protocol used, e.g. the MMC-3 protocol. In an embodiment the error reporting unit 16 generates, in the event of an unwritten area, the error message for an area corresponding to a sector. Alternatively the error message may include a multitude or a range of sectors that are unwritten.

Background information on the recording devices and storage medium formats can be found in the following references:

| | |
|---|---|
| [DVD] | Specification for Read-only disc ECMA-267 |
| [DVD + R] | 4.7 Gbytes Basic Format Specifications System |
| | Description 1.1 |
| [DVD + RW] | 4.7 Gbytes Basic Format Specifications Rewritable |
| | version 1.2 |
| | Commonly in recording systems the following |
| | definitions are used. |

Drive: The unit that interfaces to the storage medium, e.g. has an Optical Pick-up Unit, servo, data-path, memory flash, and which is interfaced to a host, e.g. with ATAPI.
Disc: Can be any optical disc, e.g. CDDA, CD-R/RW, CD-ROM, DVDROM, DVD+RW, DVD+R SACD
ECC: This is the smallest data amount that can be written on the disc. On DVD a complete EFM block of 32Kbytes user-data.
Sector: Is the minimum data size that can be addressed (on DVD) 2048 Bytes
Application: Active unit in a host to interface with, which requires realtime data to be stored on the disc (and retrieved from) the disc, and arranges the structure on the disc, and that is for example encoding/decoding the video signals.
Chunk a block of data to be written continuously without linking.
De-iced: The +RW phase change material has two states: amorphous or crystalline. All of the material on a new disc has the same state; such a disc is referred to as “iced”. By writing to the disc, transitions are created. This influences the reflectivity of the disc and how the disc can be read. If the disc contains iced areas, the current position of the laser can only be determined by via the wobble. In written areas, the position information is included in the data.
Off-Track When the laser in the optical pickup unit can not follow the (wobbled) groove on a (recordable) disc it will be off track.

In the following the medium and the protocol over the host interface 15 or ATA cable will more deeply be described. The ATA cable and its protocol, that are well-known, are described in numerous documents, e.g. the ATA/ATAPI-5 document The highest protocol level of the cable is given in MMC-3. In the following explanation the storage medium 11 is a DVD+RW medium, a recordable Digital Versatile Disc. The medium is described in the DVD+RW Physical Format Specification. There is a problem in the read command and error reporting of the protocol as given in MMC-3 and by understanding the relationship between the medium and the protocol, the solution to this problem can be understood.

When a DVD+RW disc is taken out of the fabrication, the recording layer is totally unwritten. This state is called “ICE”. It is referred as such because unwritten areas are highly reflective. Written areas are less reflective and because they contain small crystalline to amorphous transitions, which cause interferences, which result in variations of a reflected laser beam detected by the device. Unwritten areas have no interferences and result in a stable reflected laser beam. Therefore such unwritten areas appear “flat” or “slippery”, like ICE, and the ICE is detectable from the reflective state of the recording layer.

In an embodiment the error reporting is based on detecting an unwritten area by detecting a reflective state of a recording layer of the storage medium.

In an embodiment the present invention can be carried out in the implementation in the “READ (10)” or “READ (12)” command as given in the MMC-3. When executing such a read command, the device detects unwritten areas, e.g. from the reflective state as described above, and sends an error message via the host interface (15) for the sector or sectors where the unwritten state has been detected. The effect can simply be tested by creating a disc with unwritten areas and then observing how a DVD+RW writer reacts when reading over the ICED areas. An example of a read command is the definition of read (12) as described with FIG. 2.

FIG. 2 shows a read command. The read command is specified by a table defining the function of a number of bytes constituting a message to be transferred via the host interface. In a first byte 21 a command code is defined, which indicates that the message is a read command. In a second byte 22 command options are defined, and in further bytes 23 a Logical Block Address of the data to be read is defined. The length of the data transfer is defined in bytes 24. A special mode for real-time data is defined by the Streaming indicator 25. The command for reading is described in MMC-3 as the read (12) command as follows.

The READ (12) command requests that the Logical Unit transfer data to the Initiator. The most recent data value written in the addressed logical block shall be returned. Any read by the Initiator to a Logical Block with a Title Key present in the sector (DVD-ROM Media Only), when the Authentication Success Flag (ASF) is set to zero shall be blocked. The command shall be terminated with CHECK CONDITION status and SK/ASC/ASCQ values shall be set to ILLEGAL REQUEST/READ OF SCRAMBLED SECTOR WITHOUT AUTHENTICATION. The Disable Page Out (DPO) bit is not used by Logical Units and shall be set to zero. A DPO bit of zero indicates the retention priority field in the Cache Page shall determine the priority, if supported. All other aspects of the algorithm implementing the cache memory replacement strategy are vender specific. A Force Unit Access (FUA) bit of one indicates that the Logical Unit shall access the media in performing the command. Read commands shall access the specified logical blocks from the media (i.e. the data is not directly retrieved from the cache). In the case where the cache contains a more recent version of a logical block than the media, the logical block shall first be written to the media An FUA bit of zero indicates that the Logical Unit may satisfy the command by accessing the cache memory. For read operations, any logical blocks that are contained in the cache memory may be transferred to the Initiator directly from the cache memory. The Transfer Length field specifies the number of contiguous logical blocks of data that shall be transferred. A Transfer Length of zero indicates that no logical blocks shall be transferred. This condition shall not be considered an error. Any other value indicates the number of logical blocks that shall be transferred. The Streaming bit of one specifies that the Stream playback operation shall be used for the command. The Streaming bit of zero specifies that the conventional READ operation shall be used for the command. If the Streaming bit is set to one, the cache control Mode parameter may be ignored. When the Streaming bit is set to one, the FUA bit shall be set to zero. If both the Streaming bit and the FUA bit is set to one, the Logical Unit shall terminate the command with CHECK CONDITION status and SK/ASC/ASCQ values shall be set to ILLEGAL REQUEST/INVALID FIELD IN CDB.

Hence the host interface communicates with the host via messages according to a protocol (e.g. ATA/ATAPI-5), the messages including a write command for writing a series of data blocks, and a read command for reading a series of data blocks. For error reporting an error message is transferred via the host interface in the event that during reading an area is detected which is unwritten.

FIG. 3a shows connectors on a drive for interfacing. A rear side 71 of a drive is shown. The connector in the rear side of the drive is a 5-in-1 connector. A first connector 72 is a digital output, and a second connector 72 is an analogue audio output (4 pin, according to MPC-2 spec). The audio outputs may be not supported. A Master/Slave connector 73 is a 3 position jumper block, for CS (Cable Select), M (Master) and S (Slave), and a jumper 75 is shown in a position as default jumper master select. A fourth connector 76 is a 16 pin ATA-2 dual row flatcable connector, shrouded & keyed (pin 20 removed). This connector, also called IDE connector, is used for interfacing to a host via an ATA cable as described in ATA/ATAPI-5. Finally a connector 77 is a DC Power inlet according to Industry std. 4-pin Amphenol. The DC Power Connector provides the drive with DC power (+5 Volt and +12 Volt) to be supplied from an external power supply.

FIG. 3b shows an IDE connector layout defining the function of the pins. For a detailed description see ATA/ATAPI-5. The data connector is used for interfacing to a host system. The Master/Slave Connector 73 is used to install an IDE data cable depending on the existing PC configuration. There are three possibilities of connection: device as slave (jumper on Slave); device as master (jumper on Master Default); device as master or slave (jumper on Cable Select): depending on the configuration of another connected device. No Jumper also means Cable select.

Although the invention has been mainly explained by embodiments using DVD+RW optical discs, the invention is also suitable for other record carriers such as rectangular optical cards, magneto-optical discs, high-density (Blu-ray) discs or any other type of information storage system for recording series of data blocks in real time.

It is noted, that in this document the word ‘comprising’ does not exclude the presence of other elements or steps than those listed and the word ‘a’ or ‘an’ preceding an element does not exclude the presence of a plurality of such elements, that any reference signs do not limit the scope of the claims, that the invention may be implemented by means of both hardware and software, and that several ‘means’ or ‘units’ may be represented by the same item of hardware or software. Further, the scope of the invention is not limited to the embodiments, and the invention lies in each and every novel feature or combination of features described above.

1. Device for storing information on a storage medium (11),
the device comprising
medium interface means (14) for interfacing with the storage medium (11) for recording data on the medium and reading data from the storage medium,
host interface means (15) for communicating with a host (13) via messages according to a protocol, the messages including a write command for writing data and a read command for reading data, and
error reporting means (16) for reporting an error via an error message in the event that during reading an area is detected which is unwritten.

2. Device as claimed in claim 1, wherein the host interface means (15) are arranged for communicating via the messages including a write command for writing data in real-time and a read command for reading data in real-time.

3. Device as claimed in claim 1, wherein the error reporting means (16) are arranged for detecting an unwritten area by detecting a reflective state of a recording layer of the storage medium.

4. Device as claimed in claim 1, wherein the error reporting means (16) are arranged for reporting the error message for an area corresponding to a sector.

5. Method of storing information on a storage medium, the method comprising
communicating with a host via messages according to a protocol, the messages including a write command for writing data and a read command for reading data, and
reporting an error via an error message in the event that during reading an area is detected which is unwritten.

6. Method as claimed in claim 5, wherein said communicating includes sending the error message for an area corresponding to a sector.

7. Method of controlling a device for storing information on a storage medium as claimed in claim 1, the method comprising
communicating with the device via messages according to a protocol, the messages including a write command for writing data and a read command for reading data,
receiving an error message in the event that during reading an area is detected which is unwritten, and
reporting the unwritten area to an application.

8. Method as claimed in claim 7, wherein said communicating includes communicating via the messages including a write command for writing data in real-time and a read command for reading data in real-time.

9. Computer program product for storing information on a storage medium, which program is operative to cause a processor to perform the method as claimed in claim 5.
